(19) United States
(12) Patent Application Publication
(10) Pub. No.: US 2025/0223485 A1
(43) Pub. Date: Jul. 10, 2025

(54) WELLBORE FLUIDS INCLUDING SHALE INHIBITORS, AND RELATED METHODS

(71) Applicant: Schlumberger Technology Corporation, Sugar Land, TX (US)

(72) Inventors: Dimitri Khramov, Katy, TX (US); Valentin Visinescu, Katy, TX (US)

(21) Appl. No.: 18/405,409

(22) Filed: Jan. 5, 2024

(51) Int. Cl. C09K 8/22

(52) U.S. Cl. CPC C09K 8/22; C09K 2208/12

(57) ABSTRACT

A method of operating a wellbore comprises mixing a dry shale inhibitor comprising a solid amine salt with a fluid to form a drilling fluid. The drilling fluid comprises an aqueous base fluid and a shale inhibitor formed from the dry shale inhibitor, the shale inhibitor comprising the dissolved amine salt, the amine salt comprising a reaction product of at least one amine selected from the group consisting of selected from the group consisting of hexamethylenediamine, 1,8-diaminooctane, 1,10-diaminodecane, bis(para-aminocyclohexyl) methane, and tetramethyl hexamethylenediamine and at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid. The method further comprises pumping the wellbore fluid into a wellbore extending through an earth formation. Related wellbore fluids, methods of forming the dry shale inhibitor, and packages including the dry shale inhibitor are also disclosed.

### CROSS-REFERENCE TO RELATED APPLICATIONS

N/A

### BACKGROUND OF THE DISCLOSURE

Wellbore drilling operations include drilling a bore in a formation to access reservoirs of hydrocarbons and other subsurface resources. During drilling of a wellbore, various wellbore fluids may be circulated into the wellbore through a drill pipe and drill bit, and may subsequently flow upward through the wellbore to the surface. For example, a drilling fluid (e.g., an aqueous-based fluid, such as an aqueous drilling mud) may be pumped down the inside of the drill pipe, through the drill bit, and into the wellbore. The drilling fluid returns to the surface through an annulus between the drill pipe and the surfaces of the formation defining the wellbore. The drilling fluid may lubricate and cool the drill bit and simultaneously facilitate removal of formation cuttings. In addition to cooling and lubricating the drill bit, the drilling fluid may facilitate transportation of formation cuttings removed by the drill bit, suspend solids in the wellbore, and maintain a fluid pressure on the formation to prevent blowouts. Some wellbore fluids may be used to stabilize the formation through which the wellbore is being drilled, fracture the formation proximate the wellbore, displace a fluid within the wellbore with another fluid, clean or test the wellbore, transmit hydraulic power to the drill bit, and/or place a packer.

Aqueous-based wellbore fluids may be preferred since such fluids are lower in cost and/or may be more environmentally friendly than some oil-based or synthetic wellbore fluids. Selection of a suitable wellbore fluid may depend on the type of formation being drilled. Formations may be at least partially composed of clay, shales, mudstones, siltstones, and claystones, which may swell responsive to exposure to water. The swelling of such formation materials may increase drilling times and costs associated with wellbore drilling operations. For example, drilling such materials may result in bit balling, swelling or sloughing (dispersion of the shale into the wellbore fluid) of the wellbore, stuck drill pipe, and dispersion of formation cuttings. Such problems may be exacerbated as the water content of the wellbore fluid increases due to hydration of materials (e.g., clays) in the formation.

### SUMMARY

In some embodiments, a method of operating a wellbore comprises mixing a dry shale inhibitor comprising a solid amine salt with a fluid to form a drilling fluid, and pumping the wellbore fluid into a wellbore extending through an earth formation. The wellbore fluid comprises a shale inhibitor formed from the dry shale inhibitor, the shale inhibitor comprising the dissolved amine salt, the amine salt comprising a reaction product of at least one amine selected from the group consisting of selected from the group consisting of hexamethylenediamine, 1,8-diaminooctane, 1,10-diaminodecane, bis(para-aminocyclohexyl) methane, and tetramethyl hexamethylenediamine, and at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid.

In some embodiments, a method of operating a wellbore fluid comprises an aqueous base fluid, and a solid shale inhibitor dissolved in the aqueous base fluid, the solid shale inhibitor comprising a salt comprising a reaction product of at least one of hexamethylenediamine, 1,8-diaminooctane, 1,10-diaminodecane, bis(para-aminocyclohexyl) methane, or tetramethyl hexamethylenediamine, and at least one of hydrochloric acid, hydrobromic acid, hydroiodic acid, sulfuric acid, phosphoric acid, methanesulfonic acid, toluene sulfonic acid, trifluoromethanesulfonic acid, or trifluoracetic acid.

In some embodiments, a method of forming a dry shale inhibitor comprises mixing water, at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid, and at least one amine selected from the group consisting of hexamethylenediamine, 1,8-diaminooctane, 1,10-diaminodecane, bis(para-aminocyclohexyl) methane, and tetramethyl hexamethylenediamine in a reaction vessel to form a solution, reacting the at least one amine with the at least one acid to neutralize the at least one amine and form at least one amine salt, while reacting the at least one amine with the at least one acid, removing at least some of the water from the solution, and drying the neutralized amine to evaporate the water and form a solid product comprising the amine salt.

In some embodiments, a dry shale inhibitor package comprises a dry shale inhibitor comprising a reaction product of at least one amine selected from the group consisting of hexamethylenediamine, 1,8-diaminooctane, 1,10-diaminodecane, bis(para-aminocyclohexyl) methane, and tetramethyl hexamethylenediamine, and at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid. The dry shale inhibitor package further comprises instructions comprising directions for mixing the dry shale inhibitor with a wellbore fluid.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system for drilling an earth formation to form a wellbore, according to at least one embodiment of the present disclosure;

FIG. 2 is a simplified flow diagram illustrating a method of operating a wellbore, according to at least one embodiment of the disclosure; and

FIG. 3 is a simplified flow diagram illustrating a method of forming a shale inhibitor, according to at least one embodiment of the disclosure.

### DETAILED DESCRIPTION

This disclosure generally relates to devices, systems, and methods for wellbore fluid additives for downhole applications, such as one or more materials formulated and configured to inhibit (e.g., reduce) hydration, swelling, and disintegration of shales for use in downhole applications. Such materials are referred to herein as “shale inhibitors.” The shale inhibitors may be used in a wellbore fluid, such as a drilling fluid, drill-in fluid (also referred to as “reservoir drill-in fluid” (RDF)), workover fluid, or other wellbore fluids. For example, the shale inhibitors may be used in drilling fluids used to drill subterranean earth formations including at least one shale, claystone, mudstone, siltstone, or other materials that swell responsive to exposure to water. The shale inhibitor may promote the retention of the wellbore fluids in the wellbore and reduce (e.g., prevent) fluid loss due to absorption by clays and other hydrophilic materials of the earth formation.

The shale inhibitor may comprise a dry, solid material. In some embodiments, the shale inhibitor comprises an amine salt of at least one amine and at least one acid. The at least one amine may include at least one of hexamethylenediamine (HMD), 1,8-diaminooctane, 1,10-diaminodecane, bis(para-aminocyclohexyl) methane, or tetramethyl hexamethylenediamine. The at least one acid may include at least one of hydrochloric acid, hydrobromic acid, hydroiodic acid, sulfuric acid, phosphoric acid, methanesulfonic acid, toluene sulfonic acid, trifluoromethanesulfonic acid, or trifluoracetic acid. In some embodiments, the at least one acid is an inorganic acid (e.g., at least one oof hydrochloric acid, hydrobromic acid, hydroiodic acid, sulfuric acid, or phosphoric acid). In some embodiments, the amine salt comprises hexamethylenediamine hydrochloride or hexamethylenediamine dihydrochloride.

The shale inhibitor may be formed by neutralizing at least one amine with at least one acid to form the amine salt. The at least one amine and the at least one acid may be selected to form an amine salt that does not form an amide, which are ineffective at shale inhibition. The neutralization of the at least one amine may be facilitated in a solution including the at least one amine, the at least one acid, and water. The neutralization of the at least one amine may be an exothermic reaction, the heat of which may be used for evaporation of the water for forming the dried, solid amine salt. After the at least one amine is neutralized, the remaining water may be removed, such as by drying, to form the dried amine salt. Using the heat of reaction of the neutralization reaction may reduce the costs associated with drying the solution after the neutralization reaction is complete. The dried, solid amine salt may exhibit desired storage properties.

In some embodiments, the shale inhibitor comprises a substantially pure material wherein substantially an entire weight percent of the shale inhibitor comprises an active shale inhibition material. For example, since the shale inhibitor comprises a solid, the shale inhibitor may be provided to a wellbore fluid (e.g., a drilling fluid) on site, such as by mixing the shale inhibitor with the wellbore fluid in a hopper and/or in a mud pit proximate the wellbore. Mixing the shale inhibitor with the wellbore fluid may facilitate dispersion of the shale inhibitor in the wellbore fluid and, in some embodiments, dissolution of the shale inhibitor.

Since the shale inhibitor is provided as a solid, a relatively smaller volume of the shale inhibitor may be provided to the wellbore fluid to achieve a desired level of shale inhibition compared to shale inhibitors that are added in liquid form. For example, conventional shale inhibitors are provided as a liquid in which the active components are provided in a solution, requiring a higher volume of composition for a given degree of shale inhibition. The larger volume of shale inhibitors provided as a liquid composition increases storage and transportation costs of the shale inhibitor. Forming the shale inhibitor to comprise a dried, solid amine salt according to embodiments described herein, facilitates storing a relatively smaller volume of solid shale inhibitor compared to a relatively larger volume of liquid shale inhibitor having a similar quantity of active shale inhibitor. Further, conventional shale inhibitors may avoid the use of hydrochloric acid or other strong, inorganic acids to neutralize the shale inhibitor since the precipitation of the active shale inhibition component may be considered undesirable. According to embodiments described herein, the shale inhibitor is water soluble and may be effectively neutralized with a strong acid without forming undesirable amide byproducts.

In addition, selection of the amines and the acids used to neutralize the amines to form the amine salt may facilitate formation of stable salts that are non-hygroscopic (e.g., do not have a tendency to absorb water or moisture from a surrounding environment), such that the amine salt does not agglomerate, cake, or clump during storage. Thus, the amine salts may be stored in solid form and may not substantially cake, agglomerate, or harden. The amine salt may be dispersible in water, facilitating the use of the amine salt shale inhibitor on-site during wellbore operations, and reducing the impact of transporting a premixed aqueous amine shale inhibitor. Further, the amine salt may be chemically and temperature stable and may remain a solid, even at elevated temperatures, such as temperatures greater than about 90° C. By way of comparison, other amine salts (e.g., 1,2-diaminocyclohexane (DCH), bis-hexamethylene triamine (BHMT)) may be hygroscopic and agglomerate during storage as solid materials. The agglomeration may result in hardening of the amine salts, rendering them difficult to mix or provide into a wellbore fluid in solid form.

Advantageously, the amine to form the dry shale inhibitor may be provided as a byproduct of an industrial process, such as of the Nylon-6,6 process. In some instances, separation of hexamethylenediamine from other components (e.g., 1,2-diaminocyclohexane and bis-hexamethylene triamine in the Nylon-6,6 process) may not be performed to a suitable level. For example, the hexamethylenediamine stream may exhibit a hexamethylenediamine purity of about 99 percent, which may not be of high enough quality for the Nylon-6,6 process. Such streams are undesired for the Nylon-6,6 process because they do not have the required hexamethylenediamine purity. Advantageously, such steams may be used to manufacture shale inhibitors including improved properties according to embodiments of the disclosure.

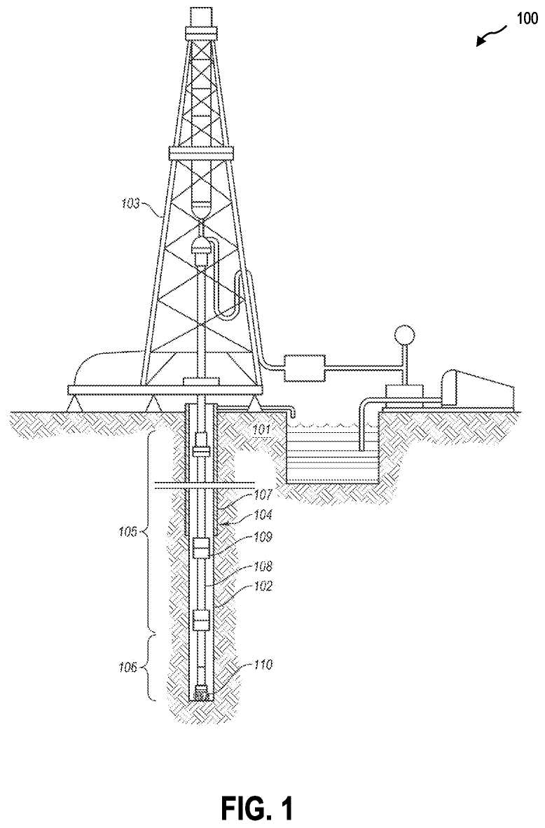

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

During drilling operations, a drilling fluid may be used to facilitate lubrication and cooling of the bit 110 and removal of earth formation 101 cuttings. In some embodiments, the drilling fluid may include one or more shale inhibitors formulated and configured to inhibit (e.g., reduce) hydration, swelling, and disintegration of shales defining the earth formation 101. For example, the shale inhibitors may be formulated and configured to reduce hydration and swelling of cuttings of the earth formation 101, reducing a tendency of loss of circulation of the drilling fluids, stuck drilling pipe (e.g., the drill string 105 and/or the drilling tool assembly 104), and a corresponding increase in drilling operation costs.

The shale inhibitors may be provided to the drilling fluids in a salt form, such as an amine salt. The amine salt may be dry (e.g., may not include water) and may be soluble in the drilling fluid. In some embodiments, the shale inhibitor is mixed with the drilling fluid at the wellbore 102, such as in a mixing tank, a hopper, or a mud pit. Since the shale inhibitors are provided to the drilling fluid in solid form as a salt, a lower weight and a lower volume of the shale inhibitors may be provided to the drilling fluid for a desired level of shale inhibition compared to addition of liquid shale inhibitors. In addition, the shale inhibitors may be formulated to comprise amine salts that are non-hygroscopic and do not tend to agglomerate, cake, or otherwise harden. In some embodiments, the shale inhibitor is provided as a substantially pure material (e.g., having a weight percent of the inhibitor greater than about 90 weight percent, greater than about 95 weight percent, or even greater than about 98 weight percent). The shale inhibitor may comprise, consist essentially of, or consist of a single type of amine salt (e.g., not more than type of amine salt).

The drilling fluid may include a base fluid, the shale inhibitor, and one or more additives (e.g., one or more of bridging materials, viscosifiers, thinners (e.g., dispersion aids), weighting materials, filtration control agents, shale stabilizers, pH buffers, emulsifiers, corrosion inhibitors, emulsion activators, gelling agents, shale inhibitors, defoamers, surfactants, foaming agents, scale inhibitors, solvents, rheological additives, or other additives).

In some embodiments, the drilling fluid comprises an aqueous-based drilling fluid and may be referred to as a “drilling mud.” The base fluid may include water, sea water, brine, or a salt-containing aqueous solution. By way of non-limiting example, the base fluid may include a brine including water and one or more salts (e.g., one or more organic salts and/or one or more inorganic salts).

The one or more salts may provide a desired density to the drilling fluid, reduce the effect of the drilling fluid on hydratable clays and shales the earth formation 101, and/or reduce (e.g., prevent) gas hydrate formation. The salts may include salts of one or more of sodium, calcium, aluminum, magnesium, zinc, potassium, strontium, or lithium, and salts of one or more of chlorides, bromides, carbonates, iodides, chlorates, bromates, formates, nitrates, oxides, phosphates, sulfates, silicates, or fluorides. In some embodiments, the salt comprises a divalent halide, such as an alkaline earth halide (e.g., calcium chloride (CaCl₂)), calcium bromide (CaBr₂)), or a zinc halide. The salt may include cesium formate (HCOOCs), sodium bromide (NaBr), potassium bromide (KBr), and cesium bromide (CsBr). The particular composition of the salt may be selected based on compatibility with the earth formation 101 and/or to match the brine phase of a completion fluid. The fluid loss material may be formulated and configured to be stable in monovalent brines and divalent brines, such as formate-based brines, halide-based brines, or other brines.

The salt may constitute from about 0.0 weight percent (e.g., such as when the base fluid comprises fresh water) to about 50.0 weight percent of the drilling fluid, such as from about 0.0 weight percent to about weight percent, from about 5.0 weight percent to about 10.0 weight percent, from about 10.0 to about 20.0 weight percent, from about 20.0 weight percent to about 30.0 weight percent, from about 30.0 weight percent to about 4.0 weight percent, or from about 40.0 weight percent to about 50.0 weight percent of the drilling fluid. However, the disclosure is not so limited, and the weight percent of the salt and the water in the drilling fluid may be different than that described.

As described above, the drilling fluid may include at least one shale inhibitor formulated and configured to inhibit (e.g., reduce) hydration, swelling, and disintegration of shales within the earth formation 101, such as during drilling operations. For example, the shale inhibitor may be formulated and configured to suppress hydration of materials of the earth formation 101 by, for example, intercalating and reducing the space between platelets (e.g., clay platelets) of the earth formation 101), reducing a volume of water molecules that can penetrate the platelets and cause swelling of such materials. The shale inhibitor may, therefore, reduce bit balling and a tendency of the drill string 104 to stick during drilling operations.

The shale inhibitor may include an amine salt comprising a reaction product of a neutralization reaction of at least one amine. The at least one amine may be neutralized with at least one acid to form the amine salt. The amine salt may be separated from water to form a shale inhibitor comprising (e.g., consisting essentially of, consisting of) a dried, solid amine salt. As described herein, the at least one acid may be selected to reduce an amount of amides formed during neutralization of the at least one amine. For example, in some embodiments, the at least one acid may not include formic acid, acetic acid, or other organic acids. In some embodiments, the at least one amine comprises, consists essentially of, or consists of a single amine, such as hexamethylenediamine. The amine salt may comprise, consist essentially of, or consist of a single amine salt, such as hexamethylenediamine hydrochloride and/or hexamethylenediamine dihydrochloride. In other embodiments the amine salt comprises hexamethylenediamine sulfate, hexamethylenediamine disulfate, hexamethylenediamine phosphate, hexamethylenediamine diphosphate, or another hexamethylenediamine salt.

The amine may be selected to exhibit desired properties, such as a desired amount of hydrophobicity. For example, the amine may be selected to exhibit hydrophobic properties to exhibit a desired interaction with the earth formation, and may exhibit a level of hydrophobicity such that the amine remains at least partially soluble in water.

The at least one amine may include comprise, consist essentially of, or consist of at least one of hexamethylenediamine, 1,8-diaminooctane, 1,10-diaminodecane, bis(para-aminocyclohexyl) methane, or tetramethyl hexamethylenediamine. In some embodiments, the amine consists essentially of or consists of one of (e.g., only one of) hexamethylenediamine, 1,8-diaminooctane, 1,10-diaminodecane, bis(para-aminocyclohexyl) methane, or tetramethyl hexamethylenediamine. In some embodiments, the amine comprises a diamine.

In some embodiments, the amine may exhibit a purity greater than about 90 percent, such as greater than about 95 percent, greater than about 97 percent, greater than about 98 percent, or greater than about 99 percent. In some embodiments, the purity of the amine is at least about 98 percent. For example, in some embodiments, the amine comprises at least 98 percent pure hexamethylenediamine. In some embodiments, the amine comprise a reaction byproduct of the Nylon-6,6 process, such as relatively pure hexamethylenediamine streams (e.g., having a hexamethylenediamine purity greater than about 95 percent, greater than about 97 percent, greater than about 98 percent, or even greater than about 99 percent), but not pure enough to be used in the Nylon-6,6 process (e.g., a purity less than about 99.9 percent hexamethylenediamine).

The at least one acid may include at one hydrochloric acid, hydrobromic acid, hydroiodic acid, sulfuric acid, phosphoric acid, methanesulfonic acid, toluene sulfonic acid, trifluoromethanesulfonic acid, or trifluoracetic acid. In some embodiments, the acid comprises hydrochloric acid and the resulting amine salt comprises an amine hydrochloride (or dihydrochloride). In some embodiments, the acid comprises hydrobromic acid or hydroiodic acid and the amine salt comprises an amine hydrobromide (or dihydrobromide) or an amine hydroiodide (or dihydroiodide), respectively. In other embodiments, the acid comprises sulfuric acid and the amine comprises an amine sulfate (or disulfate). In some embodiments, the acid comprises phosphoric acid and the amine salt comprises an amine phosphate (or diphosphate) salt. In embodiments where the acid comprises methanesulfonic acid, toluene sulfonic acid, trifluoromethanesulfonic acid, or trifluoracetic acid, the amine salt comprises an amine mesylate (or dimesylate), an amine toluene sulfonate (or disulfate), an amine triflate, or an amine trifluoroacetate, respectively.

The salt may comprise, for example, an amine (e.g., a diamine) hydrochloride, an amine hydrobromide, an amine hydroiodide, an amine phosphate, an amine sulfate, an amine mesylate, an amine toluene sulfonate, an amine triflate, or an amine trifluoroacetate. The amine may include one or more of the amines described above. In some embodiments, the salt comprises, consists essentially of, or consists of a single salt compound. The hydrochloride, hydrobromide, hydroiodide, phosphate, sulfate, mesylate, and toluene sulfonate may comprise a respective dihydrochloride, dihydrobromide, dihydroiodide, disulfate, diphosphate, dimesylate, or toluene disulfonate.

By way of non-limiting example, the amine salt may include one or more of (e.g., may comprise, consist essentially of, or consist of) a reaction product of the amine and hydrochloric acid (e.g., one or more of hexamethylenediamine hydrochloride (hexane-1,6-diammonium chloride), 1,8-diaminooctane dihydrochloride, 1,10-diaminodecane dihydrochloride, bis(para-aminocyclohexyl) methane dihydrochloride, or tetramethyl hexamethylenediamine hydrochloride); a reaction product of the amine and hydrobromic acid (e.g., one or more of hexane-1,6-diammonium bromide, octane-1,8-diaminebromide, 1,10-diaminebromide, bis(para-aminocyclohexyl) methane dihydrobromide, or tetramethyl hexamethylenediamine hydrobromide); a reaction product of the amine and hydroiodic acid (e.g., one or more of hexane-1,6-diammonium iodide, octane-1,8-diamineiodide, 1,10-diamineiodide, bis(para-aminocyclohexyl) methane dihydroiodide, or tetramethyl hexamethylenediamine hydroiodide); a reaction product of the amine and sulfuric acid (e.g., hexamethylenediamine sulfate, hexamethylenediamine disulfate, 1,8-diaminooctane sulfate, 1,8-diaminooctane disulfate, 1,10-diaminodecane sulfate, 1,10-diaminodecane disulfate, bis(para-aminocyclohexyl) methane disulfate, or tetramethyl hexamethylenediamine disulfate); a reaction product of the amine and phosphoric acid (e.g., hexamethylenediamine phosphate, hexamethylenediamine diphosphate, 1,8-diaminooctane phosphate, 1,8-diaminooctane diphosphate, 1,10-diaminodecane phosphate, 1,10-diaminodecane disulfate, bis(para-aminocyclohexyl) methane disulfate (also referred to as “4,4′-diaminodicyclohexylmethane”), or tetramethyl hexamethylenediamine disulfate); a reaction product of the amine and methanesulfonic acid (e.g., hexamethylenediamine mesylate, hexamethylenediamine dimesylate, 1,8-diaminooctane mesylate, 1,8-diaminooctane dimesylate, 1,10-diaminodecane mesylate, 1,10-diaminodecane dimesylate, bis(para-aminocyclohexyl) methane dimesylate, or tetramethyl hexamethylenediamine dimesylate); a reaction product of the amine and toluene sulfonic acid (e.g., hexamethylenediamine toluene sulfonate, hexamethylenediamine toluene disulfonate, 1,8-diaminooctane toluene sulfonate, 1,8-diaminooctane toluene disulfonate, 1,10-diaminodecane toluene sulfonate, 1,10-diaminodecane toluene disulfonate, bis(para-aminocyclohexyl) methane toluene disulfonate, or tetramethyl hexamethylenediamine toluene disulfonate); a reaction product of the amine and trifluoromethanesulfonic acid (e.g., hexamethylenediamine triflate, 1,8-diaminooctane triflate, 1,10-diaminodecane triflate, bis(para-aminocyclohexyl) methane triflate, or tetramethyl hexamethylenediamine triflate); or a reaction product of the amine and trifluoracetic acid (e.g., hexamethylenediamine trifluoroacetate, 1,8-diaminooctane trifluoroacetate, 1,10-diaminodecane trifluoroacetate, bis(para-aminocyclohexyl) methane trifluoroacetate, or tetramethyl hexamethylenediamine trifluoroacetate.

In some embodiments, the shale inhibitor is substantially free of 1,2-diaminocyclohexane (DCH) and bis-hexamethylene triamine (BHMT). In some embodiments, the shale inhibitor comprises an amine hydrochloride. In some embodiments, the shale inhibitor comprises of hexamethylenediamine hydrochloride.

The shale inhibitor may comprise a substantially pure composition, such as a substantially pure amine salt. In some embodiments, the shale inhibitor is substantially free of water and is provided to the wellbore fluid as a solid. In some such embodiments, the shale inhibitor may be provided as an amine salt having a purity greater than about 90 percent, such as greater than about 95 percent, greater than about 97 percent, greater than about 98 percent, or greater than about 99 percent.

A volume percent of the shale inhibitor in the drilling fluid may be within a range of from about 0.5 volume percent to about 5.0 volume percent, such as from about 0.5 volume percent to about 1.0 volume percent, from about 1.0 volume percent to about 1.5 volume percent, from about 1.5 volume percent to about 2.0 volume percent, from about 2.0 volume percent to about 3.0 volume percent, from about 3.0 volume percent to about 4.0 volume percent, or from about 4.0 volume percent to about 5.0 volume percent. A volume percent of the shale inhibitor in the drilling fluid may be lower than a volume percent of shale inhibitors that are provided in liquid form, which may be diluted or neutralized in a solution (e.g., including water, an acid). By way of comparison, the dry, solid shale inhibitor may be provided as a solid and may be provided at a lower concentration to achieve the same level of shale inhibition compared to shale inhibitors that are added as a liquid.

The wellbore fluid may further include a bridging material. The bridging material may include particles of at least one of calcium carbonate, zinc carbonate, barium carbonate, a coated metal oxide (e.g., hemalite, ilmenite, magnesium oxide), dolomite (calcium magnesium carbonate), colemanite, ulexite, analcite, apatite, bauxite, brucite, gibbsite, hydrotalcite, galena, hematite, magnetite, iron oxides, siderite, or celestite.

In some embodiments, the bridging material are hydrophobically coated with one or more hydrophobic functional groups. The hydrophobic groups may include, for example, one or more hydrophobic fatty acids. In some embodiments, the bridging material includes particles and hydrophobic groups chemically bonded to an oxygen atom of the particle. For example, in some embodiments, the bridging material comprises hydrophobically coated calcium carbonate, wherein one or more oxygen atoms of the calcium carbonate are bonded to a silicon atom, which is, in turn, bonded to one or more hydrophobic groups (e.g., fatty acids). In some embodiments, the hydrophobic groups of the bridging material comprise one or more of stearate, stearic acid, or oleic acid.

The bridging material may constitute from about 3.0 weight percent to about 30.0 weight percent of the wellbore fluid, such as from about 3.0 weight percent to about 5.0 weight percent, from about 5.0 weight percent to about 10.0 weight percent, from about 10.0 weight percent to about 15.0 weight percent, from about 15.0 weight percent to about 20.0 weight percent, from about 20.0 weight percent to about 25.0 weight percent, or from about 25.0 weight percent to about 30.0 weight percent of the wellbore fluid. The bridging material may be present in the wellbore fluid at a concentration within a range of from about 20.0 ppb to about 200.0 ppb, such as from about 20.0 ppb to about 40.0 ppb, from about 40.0 ppb to about 60.0 ppb, from about 60.0 ppb to about 80.0 ppb, from about 80.0 ppb to about 100.0 ppb, from about 100.0 ppb to about 125.0 ppb, from about 125.0 ppb to about 150.0 ppb, from about 150.0 ppb to about 175.0 ppb, or from about 175.0 ppb to about 200.0 ppb. However, the disclosure is not so limited, and the concentration of the bridging material in the wellbore fluid may be different than those described.

The drilling fluid may further include one or more additives selected based on the desired properties of the drilling fluid. As discussed above, and by way of non-limiting example, the one or more additional additives may include one or more of bridging materials, viscosifiers, thinners, weighting materials, filtration control agents, shale stabilizers, pH buffers, emulsifiers, corrosion inhibitors, emulsion activators, gelling agents, shale inhibitors, defoamers, surfactants, foaming agents, scale inhibitors, solvents, rheological additives, or other additives that may be suitable depending on the particular operation.

In addition to the hydrophobic bridging materials described above, the wellbore fluid may further include additional bridging materials. The additional bridging materials may include one or more of calcium carbonate, magnesium citrate, calcium citrate, calcium succinate, calcium maleate, calcium tartrate, magnesium tartrate, bismuth citrate, other suspended salts, mica, nutshells, or fibers. The additional bridging materials not include hydrophobic functional groups.

Viscosifiers of the drilling fluid may include a material formulated and configured to increase the viscosity of the drilling fluid and, optionally, to facilitate formation of a filtercake between the earth formation 101 and one or more of (e.g., each of) the drill string 105, casing 107, and liners. The viscosifier may include, for example, a polymer (e.g., a copolymer) formed from at least one acrylamide monomer and at least one sulfonated anionic monomer. In other words, the viscosifier may include a reaction product of the at least one acrylamide monomer and at least one sulfonated anionic monomer. In other embodiments, the first component comprises a higher order copolymer and/or block copolymers, such as a terpolymer, a quaternary polymer, or another higher order polymer including the at least one acrylamide monomer and the at least one sulfonated anionic monomer.

The at least one acrylamide monomer may include one or more of acrylamide, unsubstituted acrylamide, methacrylamide, N-substituted acrylamides (e.g., alkylacrylamides, N-methylolacrylamide, N-isopropylacrylaminde, diacetone acrylamide, N-alkyl acrylamide (where alkyl is C₁ to C₁₄), and N,N-dialkyl acrylamides (where alkyl is C₁ (e.g., N,N-dimethylacrylamide) to C₁₄), N-cycloalkane, N-(2-hydroxyethyl) acrylamide, N-isopropyl acrylamide, N-[3-(dimethylamino) propyl] acrylamide, or acryloyl morpholine). In embodiments wherein the at least one acrylamide monomer comprises an N-substituted acrylamide, the N-substituted acrylamide may comprise N,N-dialkyl acrylamides (e.g., N,N-dimethylacrylamide). The alkyl groups of the N,N-dialkyl acrylamides may be linear, branched, or cyclic. In some embodiments, the at least one acrylamide monomer comprises N,N-dimethylacrylamide.

The at least one sulfonated anionic monomer may include one or more of 2-acrylamido-2-methyl-propanesulfonic acid (also referred to as acrylamide tertiary butyl sulfonic acid (ATBS)), vinyl sulfonates, styrene sulfonic acid, allyl sulfonates, or styrene sulfonic acid. The at least one sulfonated anionic monomer may facilitate tolerance of the viscosifier to divalent cations in the drilling fluid brine, such as calcium and magnesium. In some embodiments, the at least one sulfonated anionic monomer is provided as a salt, such as an ammonium salt. For example, the at least one sulfonated anionic monomer may be provided as an ammonium salt of 2-acrylamido-2-methyl-propanesulfonic acid or a sodium salt of 2-acrylamido-2-methyl-propanesulfonic acid.

The viscosifier may constitute from about 0.05 weight percent to about 6.0 weight percent of the drilling fluid, such as from about 0.05 weight percent to about 0.10 weight percent, from about 0.10 weight percent to about 0.50 weight percent, from about 0.50 weight percent to about 1.0 weight percent, from about 1.0 weight percent to about 1.0 weight percent, from about 1.0 weight percent to about 2.0 weight percent, from about 2.0 weight percent to about 3.0 weight percent, or from about 3.0 weight percent to about 6.0 weight percent of the drilling fluid. In some embodiments, the viscosifier may be present in the drilling fluid at a concentration as low as 0.25 ppb. However, the disclosure is not so limited, and the weight percent of the viscosifier in the drilling fluid may be different than that described.

Wellbore fluid thinners may include lignosulfates, lignitic materials, modified lignosulfonates, polyphosphates, tannin, and polyacrylates. The thinners may facilitate improved rheological properties of the drilling fluid (e.g., a reduction in flow resistance) and a reduction in gel development. In addition, the thinner may reduce a thickness of filtercakes formed by the drilling fluid, counteract the effects of salts, and reduce the effects of water on the earth formation 101.

Weighting materials (also referred to as “weighting agents”) may include one or more of barite (BaSO₄), iron oxide (e.g., Fe₂O₃, Fe₃O₄), calcium carbonate (CaCO₃), magnesium carbonate (MgCO₃), manganese oxide (Mn₃O₄), or combinations thereof. The weighting material may be present in the drilling fluid and facilitate increasing the density of the drilling fluid up to about 2.88 g/cm³ (about 24 pounds per gallon (ppg)).

The pH buffer may include an amine stabilizer, such as one or more of triethanolamine (C₆H₁₅NO₃) (TEOA), methyldiethanol amine (C₅H₁₃NO₂) (MDEA), dimethylethanol amine (C₄H₁₁NO) (DMEA), diethanol amine (C₄H₁₁NO₂) (DEA), monoethanol amine (MEA), cyclic organic amines, sterically hindered amines, amides of fatty acid, or other suitable tertiary, secondary, or primary amines and ammonia. In some embodiments, the pH buffer includes magnesium oxide.

The emulsifiers may include calcium polyvalent metal soaps, phosphate esters, fatty acids, fatty acid soaps, alkylbenzene sulfonate, lime, amidoamines, and imidazolines. The corrosion inhibitor may include iron oxide, aluminum bisulfate, zinc carbonate, zinc chromate, an amine, or another material. The gelling agent may include one or more of a clay and a crosslinked polyvinylpyrrolidone, an acrylamide copolymer, guar, sodium bentonite, or another material. The shale inhibitor may include one or more of amine tartaric salt, ammonium lauric salt, polyammonium, alkyl diammonium, an amphoteric polymer, an organosilicate polymer, a silicone polymer, or another material. Defoamers may include one or more of 2-octanol, oleic acid, paraffinic waxes, amide waxes, sulfonated oils, organic phosphates, silicone oils, mineral oils, or dimethylpolysiloxane.

The surfactants may include anionic surfactants, cationic surfactants, and/or non-ionic surfactants. The foaming agents may include a nonionic surfactant including polymeric materials. The scale inhibitors may include an acrylic acid polymer, a maleic acid polymer, or a phosphonate. The solvents may include hydrocarbon solvents.

A density of the drilling fluid may be within a range of from about 930 kg/m³ to about 2,500 kg/m³, such as from about 930 kg/m³ to about 1,080 kg/m³, from about 1,080 kg/m³ to about 1,200 kg/m³, from about 1,200 kg/m³ to about 1,400 kg/m³, from about 1,400 kg/m³ to about 1,600 kg/m³, from about 1,600 kg/m³ to about 1,800 kg/m³, from about 1,800 kg/m³ to about 2,000 kg/m³, from about 2,000 kg/m³ to about 2,200 kg/m³, or from about 2,200 kg/m³ to about 2,500 kg/m³. However, the disclosure is not so limited, and the density of the drilling fluid may be different than that described.

The pH of the wellbore fluid may be within a range of from about 8.0 to about 10.0, such as from about 8.0 to about 9.0, or from about 9.0 to about 10.0. In some embodiments, the pH of the wellbore fluid is about 9.3. Maintaining the pH of the wellbore fluid within such a range may facilitate reducing (e.g., preventing) the formation of ammonia from the shale inhibitor in the wellbore fluid.

In use and operation, the dry shale inhibitor may be added to a wellbore fluid, such as to a drilling fluid. The wellbore fluid including the shale inhibitor may reduce (e.g., prevent) fluid loss of the wellbore fluid due to absorption by clays and other hydrophilic materials of the earth formation 101. In addition, the dry shale inhibitor may comprise a substantially pure (e.g., having a purity greater than about 90 percent) material. For example, the dry shale inhibitor may comprise, consist essentially of, or consist of an amine salt, such as a single amine salt. In some embodiments, the dry shale inhibitor consists essentially of or consists of a single amine salt, such as a hexamethylenediamine salt or an amine hydrochloride salt.

In some embodiments, use of a dry shale inhibitor may provide advantages compared to the use of multiple dry shale inhibitors. For example, a dry shale inhibitor consisting essentially of or consisting of a single amine salt may facilitate improved or easier monitoring of the concentration of the shale inhibitor in the wellbore fluid, such as by filtrate amine titration. Further, when using more than one type of shale inhibitor, different materials may be depleted at different rates, increasing a difficulty of controlling the shale inhibition of the wellbore fluid. Using a single composition (e.g., a single type of amine salt) for the shale inhibitor facilitates monitoring and controlling the concentration of the shale inhibitor and the overall shale inhibition of the wellbore fluid. In addition, the shale inhibitor may require a relatively smaller volume compared to shale inhibitors provided as a liquid, since the shale inhibitor is provided as a substantially pure salt and not in a liquid form including a water and/or an acid.

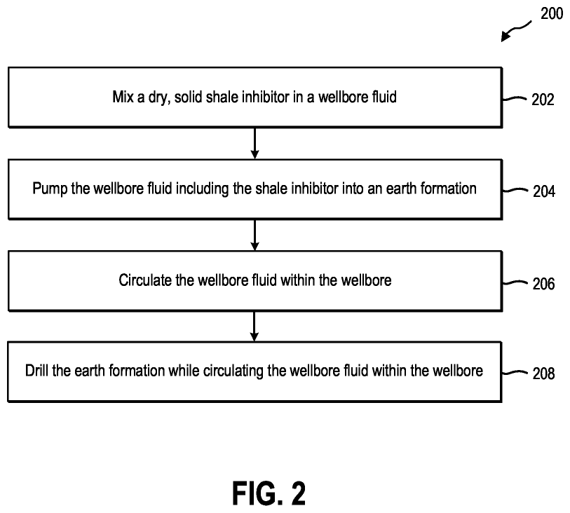

FIG. 2 is a simplified flow diagram illustrating a method 200 of operating a wellbore, according to at least one embodiment of the disclosure. The method 200 includes mixing a dry, solid shale inhibitor in a wellbore fluid, as shown in act 202. Mixing the dry, solid shale inhibitor in the wellbore fluid may include mixing a dry amine salt comprising one or more of the amine salt shale inhibitors described above in a wellbore fluid. In some embodiments the solid shale inhibitor is mixed into the wellbore fluid through a hopper. In some embodiments, the solid shale inhibitor is mixed into the wellbore fluid, such as at a mud pit. In some embodiments, mixing the dry, solid shale inhibitor in the wellbore fluid may include following instructions on packaging of the dry shale inhibitor.

Responsive to mixing the solid shale inhibitor in the wellbore fluid, the method 200 includes pumping the wellbore fluid including the shale inhibitor into an earth formation, as shown at act 204. The wellbore fluid may include, for example, a base fluid, the shale inhibitor, and one or more additives, as described above. In some embodiments, the wellbore fluid comprises a drilling fluid.

The method 200 may further include circulating the wellbore fluid within the wellbore, as shown in act 206. For example, the wellbore fluid may be circulated through the drill string, out of the drill bit 110 to the annulus, and through the annulus back to the surface of the wellbore 102.

The method 200 may further include drilling the earth formation while circulating the wellbore fluid within the wellbore, as shown at act 208. In some embodiments, the wellbore fluid is circulated through the drill string 105, out of the drill bit 110, and through the annulus between the drill string and the earth formation. The drilling fluid may facilitate removal of cuttings from the wellbore as the drilling fluid circulates through the wellbore.

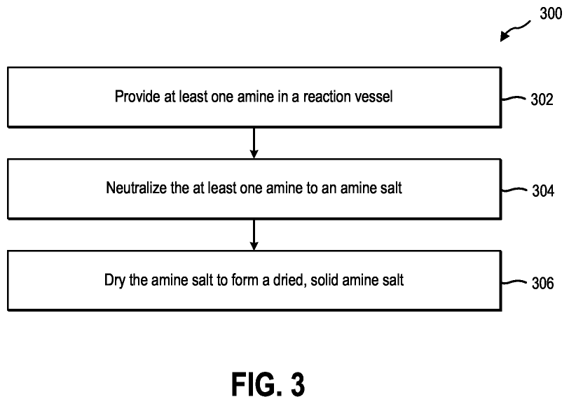

FIG. 3 is a simplified flow diagram illustrating a method 300 of forming the shale inhibitor, according to at least one embodiment of the disclosure. The method 300 includes providing at least one amine in a reaction vessel, as shown in act 302. The at least one amine may include one or more of the amines described above. For example, the at least one amine may include at least one of hexamethylenediamine, 1,8-diaminooctane, 1,10-diaminodecane, bis(para-aminocyclohexyl) methane, or tetramethyl hexamethylenediamine. In some embodiments, the amine comprises, consists essentially of, or consists of a single amine. In some embodiments, the amine is hexamethylenediamine.

The method 300 may further include neutralizing the at least one amine to form an amine salt, as shown in act 304. Neutralizing the at least one amine may include providing at least one acid to the reaction vessel to form a solution comprising the at least one amine and the at least one acid, and mixing the at least one acid with the at least one amine. In some embodiments, the at least one acid is provided as a solution comprising the at least one acid and water. The at least one acid may include one or more of the acids described above. For example, the at least one acid may include at least one of hydrochloric acid, hydrobromic acid, hydroiodic acid, sulfuric acid, phosphoric acid, methanesulfonic acid, toluene sulfonic acid, trifluoromethanesulfonic acid, or trifluoracetic acid. In some embodiments, the at least one acid comprises consists essentially of, or consists of a single acid. In some embodiments, the acid is hydrochloric acid.

Neutralizing the at least one amine may include neutralizing the at least one amine with the at least one acid and forming an amine salt. In some embodiments, the method 300 includes forming only one type of amine salt. In some embodiments, neutralizing the at least one amine may be facilitated by forming a solution exhibiting a relatively low viscosity due to the presence of water while the amine salt precipitates. The relatively low viscosity facilitates mixing of the at least one amine and the at least one acid during the neutralization reaction. Reaction of the at least one amine with the at least one acid may be an exothermic reaction. In some embodiments, act 304 includes maintaining the heat of reaction in the reaction vessel (e.g., not cooling the reaction vessel) during the neutralization of the at least one amine. In some embodiments, the heat of reaction facilitates evaporation of at least some of the water in the solution.

Responsive to neutralizing the at least one amine, the method 300 further includes drying the amine salt to form a dried, solid amine salt, as shown in act 306. Drying the amine may include drying the solution to separate the amine salt from water and may include exposing the solution to an elevated temperature for a duration (e.g., one hour), such as to a temperature greater than about 100° C. to dry the amine salt. In other embodiments, drying the solution includes spray drying the solution, drum drying the solution, cooling the solution to crystalize the amine salt followed by filtration of the solution to separate the amine salt from the solution, or drying the solution using another method. By way of non-limiting example, the solution may be spray dried wherein the solution is atomized and exposed to a drying gas in a drying chamber to separate the amine salt from the solution. The amine salt may be collected via a cyclone. In other embodiments, the solution is drum dried using one or more rotating drying drums. In yet other embodiments, the solution is cooled to cause the amine salts to crystalize. After crystallization, the crystalized amine salts may be separated from the solution by filtration.

In some embodiments, the energy (e.g., heat) for drying the solution and forming the dried, solid amine salt may be less than conventional methods since the reaction vessel was not cooled during the neutralization reaction (e.g., during act 304). In some embodiments, using the heat of reaction of the neutralization reaction may reduce an amount of energy required to dry the amine salt by up to about 25 percent, or even up to about 30 percent, reducing the operating costs of forming and drying the amine salt.

In some embodiments, the amine salt may exhibit a relatively small average particle diameter. The relatively small size of the amine salt may facilitate storage of the amine salt and may facilitate efficient mixing of the amine salt with a wellbore fluid on site. In some embodiments, since the amine salt is not formed with certain organic acids (e.g., formic acid, acetic acid) that tend to form amide salts, substantially all of the salt may comprise the amine salt. Since the salt is substantially free of amide salts, substantially all of the salt may comprise an active shale inhibitor.

In some embodiments, the at least one acid for neutralizing the at least one amsine comprises at least one of methansulfonic acid, toluene sulfonic acid, trifluoromethanesulfonic acid, or trifluoroacetic acid. In some such embodiments, the amine salts, when used as shale inhibitors according to embodiments of the disclosure, may provide unique materials (e.g., tracers) that may be used to monitor the concentration of the shale inhibitor indirectly. For example, such amine salts, when dissolved in the wellbore fluid, may form mesylate ions, sulfonate ions, triflate ions, or trifluoroacetate ions, a concentration of each of which may be monitored in the wellbore fluid to indirectly measure the concentration of the shale inhibitor.

In some embodiments, the shale inhibitor may be provided in a package (e.g., a kit) including instructions for use of the shale inhibitor. For example the shale inhibitor may be provided with instructions to perform, for example, all or a portion of the method 200. In some embodiments, the shale inhibitor is provided with instructions to mix the dry shale inhibitor with a wellbore fluid (e.g., a drilling fluid, a drilling mud), such as in a mud pit and/or a mixing hopper. The instructions may direct that the shale inhibitor be mixed with the wellbore fluid and then circulated within the wellbore, such as during drilling operations.

The embodiments of wellbore (e.g., drilling) fluids including shale inhibitors have been primarily described with reference to wellbore drilling operations; the shale inhibitors described herein may be used in applications other than the drilling of a wellbore. In other embodiments, drilling fluids including the shale inhibitors according to the present disclosure may be used outside a wellbore or other downhole environment used for the exploration or production of natural resources. For instance, drilling fluids including the shale inhibitors of the present disclosure may be used in a borehole used for placement of utility lines. Accordingly, the terms “wellbore,” “borehole,” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of operating a wellbore, the method comprising:
mixing a dry shale inhibitor comprising a solid amine salt with a fluid to form a drilling fluid comprising:
an aqueous base fluid;
a shale inhibitor formed from the dry shale inhibitor, the shale inhibitor comprising the dissolved amine salt, the amine salt comprising a reaction product of:
at least one amine selected from the group consisting of hexamethylenediamine, 1,8-diaminooctane, 1,10-diaminodecane, bis(para-aminocyclohexyl) methane, and tetramethyl hexamethylenediamine; and
at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid; and
pumping the wellbore fluid into a wellbore extending through an earth formation.

2. The method of claim 1, wherein mixing a dry shale inhibitor with a fluid comprises mixing a dry shale inhibitor comprising an amine hydrochloride with the fluid.

3. The method of claim 1, wherein mixing a dry shale inhibitor with a fluid comprises mixing a dry shale inhibitor comprising hexamethylenediamine hydrochloride with the fluid.

4. The method of claim 1, wherein mixing a dry shale inhibitor with a fluid comprises mixing a dry shale inhibitor consisting essentially of hexamethylenediamine hydrochloride with the fluid.

5. The method of claim 1, wherein mixing a dry shale inhibitor with a fluid to form a drilling fluid comprises mixing an amine sulfate salt or an amine phosphate salt with the fluid to form the drilling fluid.

6. The method of claim 1, wherein mixing a dry shale inhibitor with a fluid to form a drilling fluid comprises forming the drilling fluid to comprise within a range of from about 0.5 volume percent to about 5.0 volume percent of the shale inhibitor.

7. The method of claim 1, wherein mixing a dry shale inhibitor comprising a solid amine salt with a fluid to form a drilling fluid comprises mixing the dry shale inhibitor with the fluid proximate the wellbore.

8. A wellbore fluid, comprising:
an aqueous base fluid; and
a solid shale inhibitor dissolved in the aqueous base fluid, the solid shale inhibitor comprising a salt comprising a reaction product of:
at least one of hexamethylenediamine, 1,8-diaminooctane, 1,10-diaminodecane, bis(para-aminocyclohexyl) methane, or tetramethyl hexamethylenediamine; and
at least one of hydrochloric acid, hydrobromic acid, hydroiodic acid, sulfuric acid, phosphoric acid, methanesulfonic acid, toluene sulfonic acid, trifluoromethanesulfonic acid, or trifluoracetic acid.

9. The wellbore fluid of claim 8, further comprising at least one viscosifier.

10. The wellbore fluid of claim 8, wherein the solid shale inhibitor constitutes from about 0.5 volume percent to about 5.0 volume percent of the wellbore fluid.

11. The wellbore fluid of claim 8, wherein the solid shale inhibitor consists essentially of hexamethylenediamine hydrochloride.

12. The wellbore fluid of claim 8, wherein the solid shale inhibitor comprises an amine sulfate salt or an amine phosphate salt.

13. The wellbore fluid of claim 8, wherein the solid shale inhibitor comprises a salt of hexamethylenediamine.

14. The wellbore fluid of claim 8, wherein the solid shale inhibitor comprises an amine methylate salt.

15. The wellbore fluid of claim 8, wherein the solid shale inhibitor comprises at least one of an amine toluene sulfonate salt, an amine triflate salt, or an amine trifluoroacetate salt.

16. A method of forming a dry shale inhibitor, the method comprising:
mixing water, at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid, and at least one amine selected from the group consisting of hexamethylenediamine, 1,8-diaminooctane, 1,10-diaminodecane, bis(para-aminocyclohexyl) methane, and tetramethyl hexamethylenediamine in a reaction vessel to form a solution;
reacting the at least one amine with the at least one acid to neutralize the at least one amine and form at least one amine salt;
while reacting the at least one amine with the at least one acid, removing at least some of the water from the solution; and
drying the neutralized amine to evaporate the water and form a solid product comprising the amine salt.

17. The method of claim 16, wherein reacting the at least one amine with the at least one acid to neutralize the at least one amine and form at least one amine salt comprises forming an amine salt comprising an amine hydrochloride.

18. The method of claim 16, wherein reacting the at least one amine with the at least one acid to neutralize the at least one amine and form at least one amine salt comprises forming substantially pure hexamethylenediamine hydrochloride.

19. The method of claim 16, wherein reacting the at least one amine with the at least one acid to neutralize the at least one amine and form at least one amine salt comprises forming the at least one amine salt to comprise a hexamethylenediamine salt.

20. The method of claim 16, wherein drying the neutralized amine comprises at least one of exposing the solution to a temperature of at least about 100° C., spray drying the solution, or drum drying the solution.

21. A dry shale inhibitor package, comprising:
a dry shale inhibitor comprising a reaction product of:
at least one amine selected from the group consisting of hexamethylenediamine, 1,8-diaminooctane, 1,10-diaminodecane, bis(para-aminocyclohexyl) methane, and tetramethyl hexamethylenediamine; and
at least one acid selected from the group consisting of hydrochloric acid, hydrobromic acid, hydroiodic acid, sulfuric acid, phosphoric acid, methanesulfonic acid, toluene sulfonic acid, trifluoromethanesulfonic acid, and trifluoracetic acid; and
instructions comprising directions for mixing the dry shale inhibitor with a wellbore fluid.
